(19) United States
(12) Patent Application Publication
(10) Pub. No.: US 2018/0373348 A1
(43) Pub. Date: Dec. 27, 2018

(54) SYSTEMS AND METHODS OF ACTIVE BRIGHTNESS DEPTH CALCULATION FOR OBJECT TRACKING

(71) Applicant: Microsoft Technology Licensing, LLC, Redmond, WA (US)

(72) Inventors: Raymond Kirk PRICE, Redmond, WA (US); Michael BLEYER, Seattle, WA (US); Denis DEMANDOLX, Bellevue, WA (US)

(21) Appl. No.: 15/630,113

(22) Filed: Jun. 22, 2017

(51) Int. Cl. G06F 3/03; G01J 5/08; G06K 9/20; G01J 5/02; G01B 11/03

(52) U.S. Cl. CPC G06F 3/0312; G01J 5/0896; G01B 11/03; G01J 5/0265; G06K 9/2036

(57) ABSTRACT

A method of object tracking in a head-mounted display includes illuminating a field of view with an infrared illumination source, capturing an infrared illuminated frame of the field of view with an infrared camera, detecting a tracking object in the field of view, calculating an x-position and a y-position of the tracking object in the field of view, measuring a maximum brightness of the tracking object, and calculating a position of the tracking object using the maximum brightness.

### CROSS-REFERENCE TO RELATED APPLICATIONS

N/A

### BACKGROUND

Virtual reality (VR) and mixed reality (MR) display systems allow a user to experience visual simulations presented from a computer. Some visual simulations are interactive and allow the user to interact with the simulated environment. A user can interact with the simulated environment by spatial and orientation tracking of the display system and peripheral controllers, such as handheld devices.

Spatial and orientation tracking of peripheral controllers can include a variety of tracking methods. Conventional tracking includes incorporation of inertial measurement unit (IMU) or gyroscopic sensors, magnetic field-based tracking, acoustic tracking based on microphone array, camera-based tracking with a light-emitting diode array, or depth cameras (structured light and/or time-of-flight). Conventional low-cost options compromise precision, while higher-precision options have increased resources associated with their power or cost.

### SUMMARY

In some embodiments, an object tracking system includes an infrared illumination source mounted to a head mounted display; an infrared sensitive camera mounted to the head mounted display; and a handheld electronic device. The handheld electronic device includes a tracking object with a known reflectivity in the infrared range.

In other embodiments, a method of object tracking in a head-mounted display includes illuminating a field of view with an infrared illumination source, capturing an infrared illuminated frame of the field of view with an infrared camera, detecting a tracking object in the field of view, calculating an x-position and a y-position of the tracking object in the field of view, measuring a maximum brightness of the tracking object, and calculating a position of the tracking object using the maximum brightness.

In yet other embodiments, a method of object tracking in a head-mounted display includes illuminating a field of view with an infrared illumination source mounted to the head-mounted display, capturing an infrared illuminated frame of the field of view with an infrared camera mounted to the head-mounted display, detecting a first tracking object on a handheld device in the field of view, calculating a first x-position and a first y-position of the first tracking object in the field of view, measuring a first maximum brightness of the first tracking object, calculating a first depth of the first tracking object using the first maximum brightness, detecting a second tracking object on the handheld device in the field of view, calculating a second x-position and a second y-position of the second tracking object in the field of view, measuring a second maximum brightness of the second tracking object, and calculating a second depth of the second tracking object using the second maximum brightness.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a perspective view of an embodiment of a head-mounted display (HMD) with an illuminator and camera, according to at least one embodiment of the present disclosure;

FIG. 2 is a schematic representation of tracking a tracking object, according to at least one embodiment of the present disclosure;

FIG. 3 is a side cross-sectional view of an embodiment of a retroreflective surface of a tracking object, according to at least one embodiment of the present disclosure;

FIG. 4 is a side cross-sectional view of an embodiment of a Lambertian coating on a tracking object, according to at least one embodiment of the present disclosure;

FIG. 5-1 is a schematic representation of measuring an area of a tracking object at a first distance, according to at least one embodiment of the present disclosure;

FIG. 5-2 is a schematic representation of measuring an area of a tracking object at a second distance, according to at least one embodiment of the present disclosure;

FIG. 5-3 is a representation of an embodiment of a photoreceptor array imaging a tracking object, according to at least one embodiment of the present disclosure;

FIG. 6 is a flowchart illustrating an embodiment of a method of calculating depth, according to at least one embodiment of the present disclosure;

FIG. 7 is a flowchart illustrating an embodiment of a method of calibrating a system for brightness-based depth calculations, according to at least one embodiment of the present disclosure;

FIG. 8 is a chart showing an embodiment of a measured brightness versus distance from a camera, according to at least one embodiment of the present disclosure;

FIG. 9 is a flowchart illustrating an embodiment of a method calculating depth with multiple operating modes, according to at least one embodiment of the present disclosure;

FIG. 10 is a perspective view of an embodiment of a handheld device with a tracking object connected thereto, according to at least one embodiment of the present disclosure;

FIG. 11 is a perspective view of an embodiment of a handheld device with two tracking objects connected thereto, according to at least one embodiment of the present disclosure; and

FIG. 12 is a perspective view of an embodiment of a handheld device with three tracking objects connected thereto, according to at least one embodiment of the present disclosure.

### DETAILED DESCRIPTION

This disclosure generally relates to devices, systems, and methods for providing an interactive virtual environment to a user. More specifically, the present disclosure relates to object tracking in the physical environment during presentation of a virtual environment to a user. In some embodiments, a virtual reality (VR) or mixed reality (MR) system may be a head mounted display (HMD) worn by a user. The HMD may include a display that replaces the user's view of their surroundings with a virtual environment. The user may interact with the virtual environment through movements of objects in the physical environment. For example, a HMD may include one or more sensors that detect and track the position and/or orientation of objects in the physical environment around the user and import the position and orientation information into the virtual environment. In some embodiments, the HMD may detect and track the position of handheld objects held by the user to calculate and import the position and orientation of the user's hands.

The HMD may include an active illumination system that is used to illuminate the tracking object on the handheld device. The active illumination system may output a known illumination power. The tracking object may have a known reflectivity in the illumination wavelength range, and the brightness of the tracking object observed by a camera on the HMD may allow the calculation of a depth of the tracking object relative to the HMD. Capturing an actively illuminated frame with the camera and subtracting an ambiently illuminated frame may allow for brightness-based depth calculations in different amounts of ambient illumination.

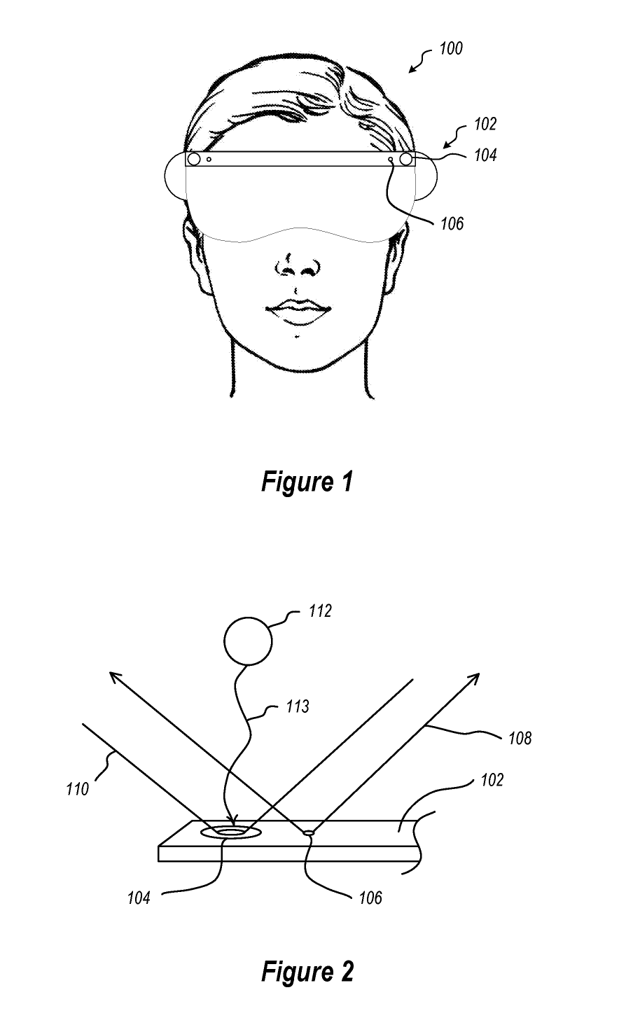

FIG. 1 is a perspective view of a user 100 wearing an HMD 102. The HMD 102 may have at least one camera 104 and at least one active illuminator 106. In some embodiments, the illuminator 106 may provide an output light in an illumination wavelength range and the camera 104 may be sensitive in at least the illumination wavelength range. For example, the illuminator 106 may provide an output light in the infrared (IR) range and the camera 104 may be an IR camera. In other examples, the illuminator 106 may provide light in the visible range or in the ultraviolet range.

The HMD 102 may include a plurality of cameras 104. Each camera 104 may have a field of view (FOV). The cameras 104 may be displaced by a distance to allow simultaneous capture with partially overlapping FOVs. In some embodiments, the plurality of cameras 104 may allow for parallax in the image, which may provide redundancy in depth calculations. In other embodiments, the plurality of cameras 104 may allow for a plurality of perspectives in the event of partial or complete occlusion of an object being tracked. In other embodiments, the plurality of cameras 104 may capture interleaved frames to provide an effective frame rate greater than either camera 104 may provide individually.

In some embodiments, the illuminator 106 may include a light emitted diode. In other embodiments, the illuminator 106 may include a laser. In some embodiments, a HMD 102 may include a plurality of illuminators 106. For example, a HMD 102 may have at least one illuminator 106 for each camera 104. In other examples, the HMD 102 may have one illuminator 106 that illuminates a field of illumination (FOI) for more than one camera 104. In yet other examples, the HMD 102 may have a plurality of illuminators that allow a plurality of operating modes and/or illumination powers.

Conventional object tracking systems use a remote tracking sensor to track the movement of an HMD and the movement of handheld objects to correlate the relative position of the HMD and the handheld objects in the virtual environment presented to the user in the HMD. An object tracking system according to the present disclosure may track the objects relative to a perspective of the HMD 102, which may approximate the perspective of the user in the virtual environment reducing associated processing loads.

FIG. 2 schematically illustrates the camera 104 and illuminator 106 of FIG. 1 tracking an object. The illuminator 106 may illuminate a FOI 108 in front of the HMD 102. In some embodiments, the FOI 108 may have an angular width of be in a range of 60°, 70°, 80°, 90°, 100°, 110°, 120°, 130°, 140°, 150°, 160°, 170°, or any values therebetween. For example, the FOI 108 may have a width of at least 60°. In other examples, the FOI 108 may have a width less than 170°. In yet other examples, the FOI 108 may have a width between 60° and 170°. In further examples, the FOI 108 may have a width between 90° and 160°. In at least embodiment, the FOI 108 may be adjustable.

The camera 104 may have a FOV 110 that overlaps the FOI 108 such that the camera 104 may collect a frame that is at least partially illuminated by the illuminator 106. In some embodiments, the FOV 110 may be substantially the same as the FOI 108 such that the camera 104 may capture the area illuminated by the illuminator 106. In other embodiments, the FOV 110 may be less than the FOI 108 such that the camera 104 may capture an area that is entirely within the FOI 108.

In some embodiments, the FOV 110 may have an angular width of be in a range of 60°, 70°, 80°, 90°, 100°, 110°, 120°, 130°, 140°, 150°, 160°, 170°, or any values therebetween. For example, the FOV 110 may have a width of at least 60°. In other examples, the FOV 110 may have a width less than 170°. In yet other examples, the FOV 110 may have a width between 60° and 170°. In further examples, the FOV 110 may have a width between 90° and 160°. In at least embodiment, the FOV 110 may be adjustable.

The illuminator 106 may illuminate a tracking object 112 within the FOI 108. The tracking object 112 may reflect at least a portion of the output light back toward the camera 104 as a reflected light 113. The reflected light 113 may be received by the camera 104 and a brightness of the reflected light measured. The measured brightness can be used to calculate a distance from the tracking object 112 to the camera 104 and HMD 102.

The intensity of illumination from the illuminator 106 to the tracking object and from the tracking object 112 back to the camera 104 each decreases according to the relationship P_{R}=P₀(1/R²) where P is the optical power and R denotes a radial distance from the source of the illumination, assuming total reflection of the incident light on the tracking object 112. Therefore, the illumination power experienced by the tracking object 112 is the illumination power of the illuminator 106 multiplied by 1/R², where R is the distance from the illuminator 106 to the tracking object 112. The measured brightness of the tracking object 112 observed by the camera 104 is the power of the reflected light 113 multiplied by 1/R² where R is the distance from the tracking object 112 to the camera 104. As the illuminator 106 and the camera 104 may be adjacent to one another, the measured brightness of the tracking object 112 is the equivalent of the illumination power of the illuminator 106 multiplied by 1/(2R)², assuming total reflection of the incident light on the tracking object 112. Because the tracking object 112 may not reflect 100% of the incident light from the illuminator 106, in order to calculate the distance to the tracking object 112 based on the measured brightness, both the reflectivity of the tracking object 112 and illumination power of the illuminator 106 must be known.

A tracking object 112 with higher reflectivity and/or reliable reflectivity irrespective of orientation relative to the HMD 102 may allow more accurate depth calculations. In some embodiments, the tracking object 112 may be substantially spherical or partially spherical (e.g., hemispherical) such that at least a portion of the surface of tracking object 112 may be normal to the HMD 102 as the tracking object 112 moves and/or changes orientation. In other embodiments, the tracking object 112 may have other shapes, including ellipsoid, ovoid, geoid, regular polygonal, oblong, irregular, lens, or combinations thereof.

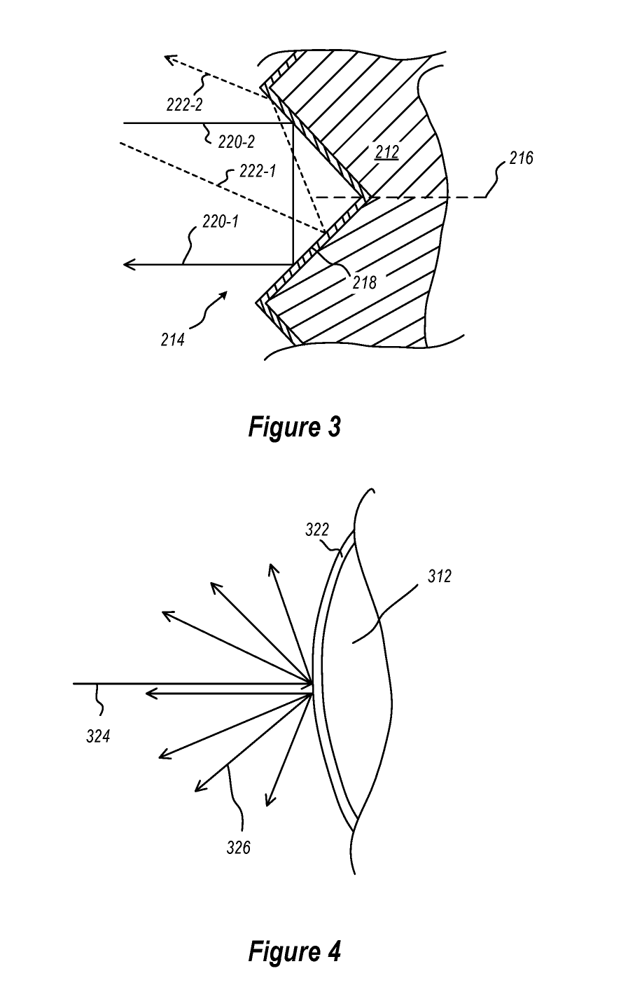

In various embodiments, tracking objects 112 may include surface features or treatments to control or improve reflectivity, such as retroflectors, Lambertian coatings, etc. FIG. 3 is a side cross-sectional view of an embodiment of a tracking object 212 with a plurality of retroreflectors 214. A retroreflector 214 may be configured to reflect incident light (within 45° of a normal axis 216 of the retroreflector 214) back toward the source of the incident light of the incident angle relative to a normal axis 216. For example, each retroreflector 214 in a surface of the tracking object 212 may have a plurality of reflective surfaces (or a single conical surface) that are oriented at 45° about the normal axis 216 such that the opposing reflective surfaces 218 are oriented at 90° relative to one another. In some embodiments, the reflective surfaces 218 may be highly reflective, providing a near 100% reflectivity for Lambertian surface, or greater than 100% effective reflectivity with the use of retroreflective materials.

The reflective surfaces 218 about the normal axis 216 may reflect incident light 220-1 from one side of the retroreflector 214 to an opposing side of the retroreflector 214, which then reflects a reflected light 220-2 back toward the source. The incident light 220-1 and the reflected light 220-2 may have parallel paths after two 90° reflections by the reflective surfaces 218. The first incident light 220-1 is shown oriented substantially normal the retroreflector 214 (i.e., parallel to the normal axis 216 of the retroreflector 214) in a case where the retroreflector 214 is facing the illuminator. A retroreflector 214, however, may also provide near 100% reflectivity when the illuminator is positioned at an angle to the retroreflector 214.

A second incident light 222-1 is incident to the retroreflector 214 at a non-normal angle. For example, the second incident light 222-1 may reflect off the reflective surface 218 at a 30° incident angle to the reflective surface 218. The 90° orientation of the reflective surfaces 218 may produce a 60° incident angle at the second reflective surface 218. The resulting second reflected light 222-2 is parallel to the second incident light 222-1 after a series of 60° and 120° reflections.

FIG. 4 is a side cross-sectional view of another embodiment of a tracking object 312 with a coating 322 to control the reflectivity of the tracking object 312. While FIG. 4 illustrates a coating 322, the material of the tracking object 312 may be selected to control the reflectivity of the tracking object 312. In some embodiments, a coating 322 may be, at least partially, a Lambertian reflector. A Lambertian reflector, along known as a matte surface, may reflect a diffuse reflected light 326 in substantially all directions. In partially Lambertian reflectors, the distribution of reflected light may change depending on the direction of the incident ray 324. For example, a perfectly Lambertian reflector may reflect light in all directions irrespective of the incident light ray, while an imperfect Lambertian reflector may be at least partially specular and reflect a greater proportion of the light according to the Law of Reflection based on an incident angle.

In some embodiments, a tracking object may have a specular surface. A specular surface may reflect only a single reflected ray for each incident ray at an equal and opposite angle to the incident angle. For example, a spherical tracking object with a specular surface would produce a single point of reflected light from the perspective of the camera. In at least one embodiment, a tracking object may include a combination of Lambertian and specular reflectivity to provide a known reflectivity for the depth calculations.

The brightness of the tracking object may be measured at a point within the detected tracking object with a maximum brightness. In some examples, the point of maximum brightness may be a centroid of the tracking object. In other examples, the point of maximum brightness may be a pixel within a facet or other region of the tracking object with equivalent brightness. FIGS. 5-1 and 5-2 illustrate a HMD 402 tracking a tracking object 412 at the depth of the tracking object 412 changes.

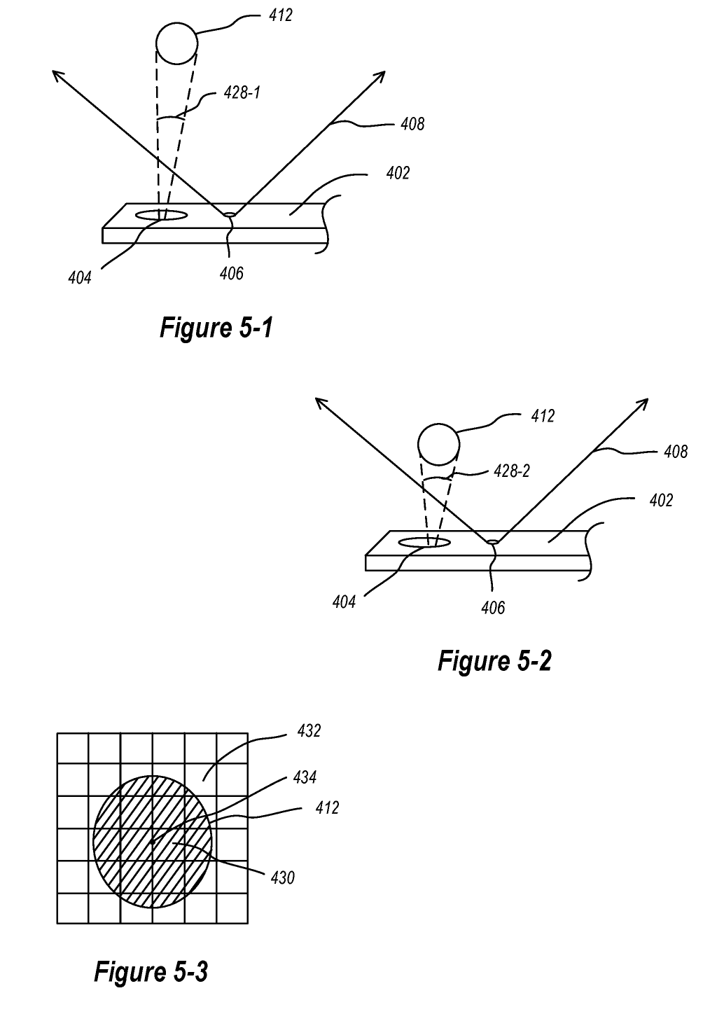

FIG. 5-1 shows a tracking object 412 a first depth from a HMD 402. An illuminator 406 may illuminate the tracking object 412 within a FOI 408. A portion of the illumination may be reflected back to the camera 404. The camera 404 may measure a size of the tracking object 412 that is a first solid angle 428-1 and collects an illuminated frame. The first solid angle 428-1 defines an area within the frame collected by the camera 404. The tracking object 412, in the illuminated frame collected by the camera 404, may have a maximum brightness and an area.

The maximum brightness may be used to calculate a depth of a point of the tracking object 412. The area may be used to confirm, or as a check against, the depth calculated by the brightness-based calculation. For example, FIG. 5-2 illustrates the HMD 402 tracking the tracking object 412 as the tracking object 412 moves closer to the camera 404. In FIG. 5-2, a solid angle 428-2 of the tracking object 412 relative to camera 404 may increase. As the depth decreases, the maximum brightness of the tracking object 412 may also increase. In some embodiments, the relative change in size of the tracking object 412 may be used to confirm a relative change in maximum brightness of the tracking object 412. In other embodiments, the tracking object 412 may have a known geometry and/or size, and the HMD 402 may calculate a depth of the tracking object 412 based on the measured area and/or other dimension of the tracking object 412.

The HMD 402 may compare the depth calculation derived from the maximum brightness and the depth calculation derived from the area of the tracking object 412 to confirm each. In other embodiments, the HMD 402 may compare the depth calculation derived from the maximum brightness and the depth calculation derived from the area of the tracking object 412 to determine when to calibrate the system. For example, if the depth calculation derived from the maximum brightness and the depth calculation derived from the area of the tracking object 412 differ by more than 1%, 2%, 5%, or 10%, the HMD 402 may present an alert or other communication to the user to calibrate.

Both the maximum brightness and the area of the tracking object 412 may be measured from a single frame collected by the camera 404. FIG. 5-3 illustrates an example portion of an illuminated frame including a tracking object 412. The camera may include a plurality of pixels in a photoreceptor array. Each of the pixels may have a finite area that can collect information from a solid angle of the FOV. Some of the pixels that capture the tracking object 412 may be complete pixels 430, and some of the pixels that capture the tracking object 412 may be partial pixels 432. A maximum brightness may be collected at a centroid 434 of the tracking object 412. The centroid 434 may be determined if there is at least one complete pixel. The area of the tracking object 412 is more sensitive to low resolution images, because area calculations require more pixels to approximate the size of the object. The brightness-based depth calculation is a more robust depth calculation, but the area-based depth calculation can be used to verify the depth.

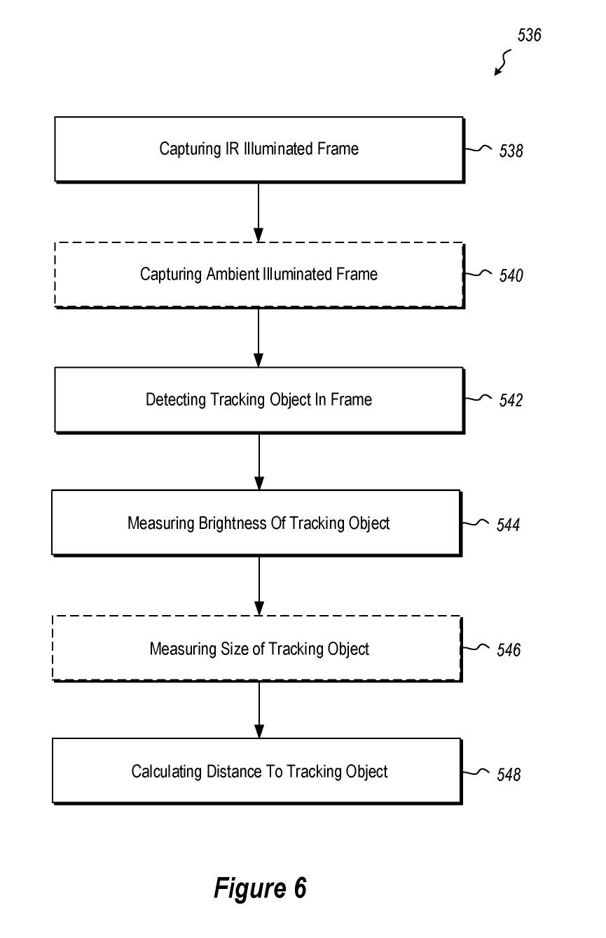

Using an embodiment of a system described herein, the depth of a tracking object may be calculated according to an embodiment of a method as shown in FIG. 6. The method 536 of calculating depth may include capturing an infrared-illuminated frame at 538. As described herein, an HMD may include both an illuminator and a camera. The illuminator may illuminate a FOI in a wavelength range. In at least embodiment, the illuminator may illuminate the FOI in an IR wavelength range. The camera may be sensitive in the IR range to capture the IR-illuminated frame. The method 536 may, optionally, include capturing an ambient light illuminated frame at 540 to subtract ambient light from the IR-illuminated frame. The resulting “corrected frame” may present the brightness of the FOV due only to the illumination of the illuminator irrespective of ambient or environmental lighting.

After capturing an IR-illuminated frame, the method 536 may include detecting a tracking object in the frame at 542. Detecting the tracking object in the frame may be based at least partially upon identifying a brightness, a size, a shape, or other predetermined property of the tracking object. In some embodiments, one or more thresholds may be applied to object tracking. For example, a handheld tracking object may return a positive detection only if the size or shape of the tracking object is within a predetermined range. In such example, an object in the IR-illuminated frame or corrected frame may be excluded if the object has an area more than 1%, 2%, 5%, or 10% of the frame area. In other examples, a tracking object may be known to have a substantially spherical shape. Any objects detected in the IR-illuminated frame or corrected frame having a non-spherical shape may be excluded from calculations.

Upon detecting the tracking object, the method 536 may further include measuring a maximum brightness of the tracking object at 544. In some embodiments, measuring the maximum brightness of the tracking object may include measuring the brightness of a centroid of the tracking object. In other embodiments, a maximum brightness may be another location on the tracking object. For example, the tracking object may be a non-spherical object, and the maximum brightness may be located at a location that is normal to the illuminator, a location that is normal to the camera, or therebetween.

In some embodiments, the method 536 may optionally include measuring a size of the tracking object 546, as described in relation to FIG. 5-1 through 5-3. Measuring a size of the tracking object may allow for a concurrent depth calculation if the tracking object has a known or expected size, allowing for a secondary confirmation of the accuracy of any depth calculation.

After measuring a maximum brightness of the tracking object at 544, the method 536 includes calculating a distance to the tracking object at 548. The depth calculation may be based at least partially upon the 1/R² change in illumination power, as described in relation to FIG. 2, relative to an expected maximum illumination power. Additionally, the depth calculation may be based at least partially upon a coefficient of reflectivity. For example, a retroreflective surface, such as described in relation to FIG. 3, may have approximately 100% reflectivity. A Lambertian surface, such as described in relation to FIG. 4, may have less than 100% reflectivity. The distance to the tracking object may provide a depth of the tracking object in the frame of the camera using only a two-dimensional image.

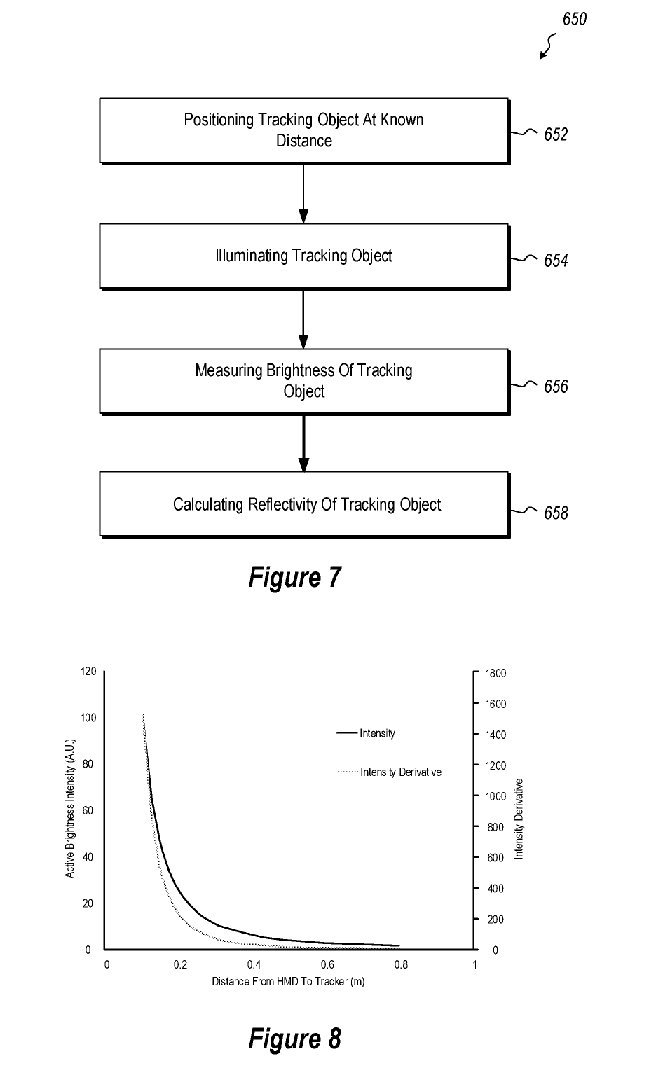

In some embodiments, a tracking system may require calibration. For example, a mismatch between a brightness-based depth calculation and a size-based depth calculation may prompt a notification that a calibration is needed. In some examples, the reflectivity of the tracking object may change over time due to damage to the surface, accumulation of dirt on the surface, or other degradation of the system. FIG. 7 is a flowchart illustrating a method 650 of calibrating a system according to the present disclosure.

To calibrate the system to calculate brightness-based depth of a tracking object, a method 650 includes positioning a tracking object at a known distance. For example, the tracking object may be positioned at a distance in a range of expected usage, such as 0.5 meters for a handheld device. The method may include illuminating the tracking object with an illuminator at 654 and measuring a brightness of the tracking object with a camera at 656. As describe herein, assuming perfect reflectivity, the theoretical brightness should be calculated by P_{R}=P₀(1/R²), where the initial optical power, the measured optical power, and the distance are all known. The difference between the theoretical brightness at the camera and the measured brightness at the camera may be used to calculate the reflectivity of the tracking object at 658. The new value for the reflectivity may be used for future depth calculations.

FIG. 8 is a chart showing a theoretic brightness of a tracking object at different distances from an HMD. The chart is normalized to 100 A.U. for the Active Brightness Intensity (the active brightness being the brightness due to active illumination in a corrected frame). A measured brightness of the tracking object in a corrected frame may be correlated to a distance on the chart. The intensity derivative on the chart shows the relative accuracy of the depth measurement. As the active brightness falls off fastest when the tracker is in close proximity to the camera module, for example, the embodiment of a tracking system depicted in the chart is most accurate in the regions below 0.4 m.

The chart is normalized based on a theoretical saturation point of a camera. In some embodiments, the accuracy may be improved by increasing the optical power of the illuminator, as the expense of saturating the camera at a smaller distance. In some embodiments, an illuminator may have a plurality of operating modes. For example, the illuminator may have an adjustable drive current. In other examples, the illuminator may include a plurality of illuminators that may allow for different optical powers. In yet other examples, the illuminator may include one or more lenses to concentrate the optical power in a smaller FOI.

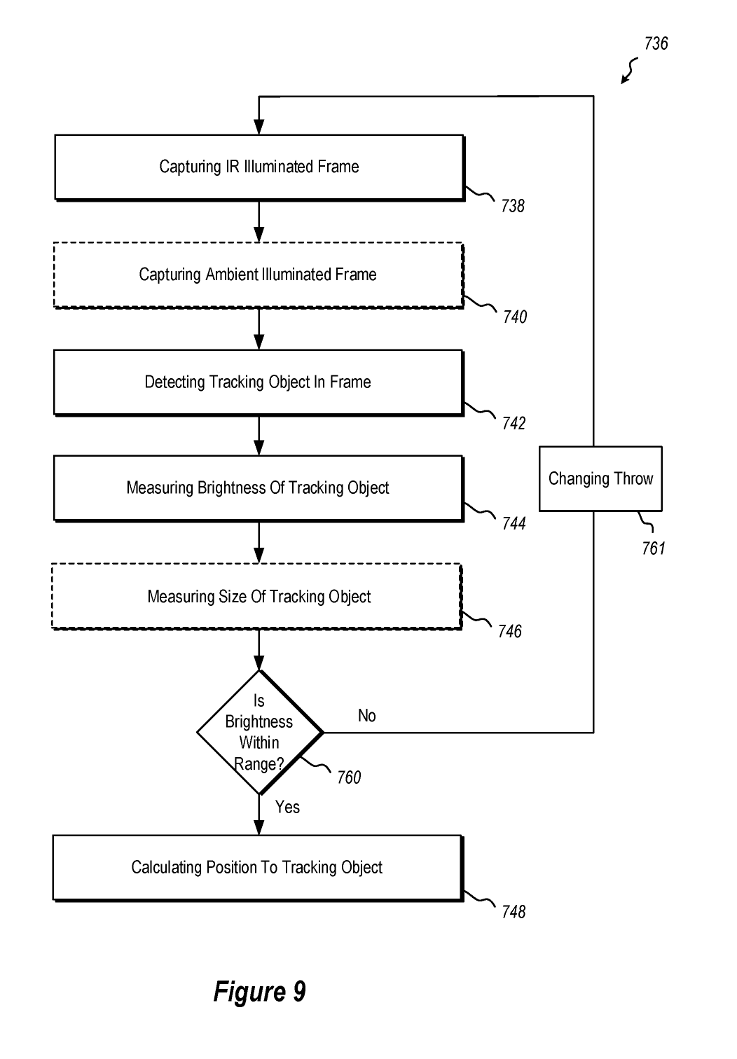

FIG. 9 illustrates another embodiment of a method of depth calculation that includes an illumination power variation. The method 736 may include similar acts as the method 536 described in relation to FIG. 6 including capturing an IR illuminated frame at 738 and optionally capturing an ambient light illuminated frame to produce a correct frame at 740, and then detecting the tracking object at 742 and measuring the brightness of the tracking object at 744. The system may optionally measure the size of the tracking object, as well, at 746. Upon measuring the brightness of the tracking object, the method 736 may include comparing the brightness to a predetermined range at 760 and potentially changing a throw length of the illuminator at 761 before calculating a depth position of the tracking object at 748.

In some embodiments, the illuminator may have two or more operating modes, such as a short throw operating mode, an intermediate throw operating mode, a long throw operating mode, etc. A HMD that measures a brightness between 5 and 99 on the chart illustrated in FIG. 8 may calculate the depth of the tracking object from the measured brightness at 748 of the method 736 in FIG. 9. If the measured brightness is about 100, and the photoreceptor array of the camera is saturated, the HMD may change the illuminator operating mode from the intermediate operating mode to the short throw operating mode at 761 and repeat the capture and measurement process of the method 736. If the measured bright is below 5 A.U., or another predetermined threshold, at 760, the HMD may change the illuminator operating mode to a greater illumination power, such as a long throw operating mode at 761.

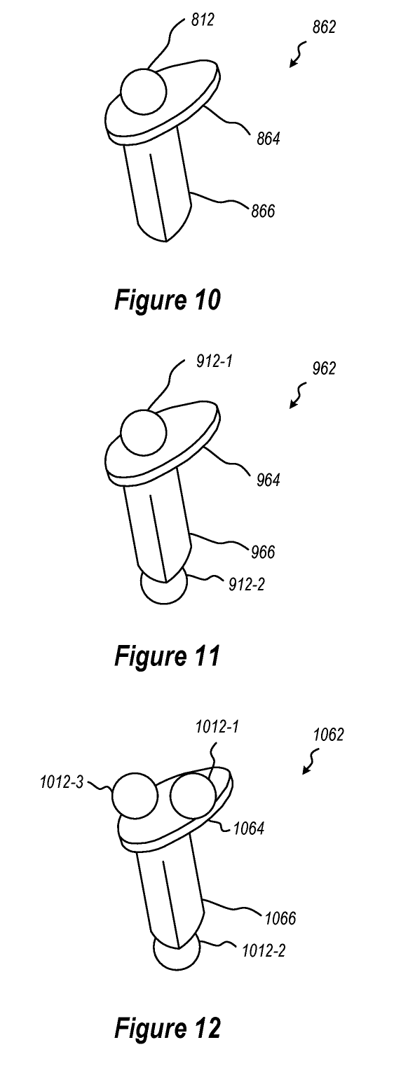

FIG. 10 through FIG. 12 illustrate embodiments of a handheld device 862, 962, 1062 that may include one or more tracking objects to provide a depth information in concert with other sensors on the handheld device. FIG. 10 is a perspective embodiment of a handheld device 862 with a spherical tracking object 812 positioned on the handheld device 862. Detection and measurement of the tracking object 812 by a camera on a HMD may provide X-, Y-, and Z-coordinate information relative to the FOV of the HMD. In some embodiments, the handheld device 862 may include a gyroscope 864 and/or an inertial movement unit (IMU) 866 to provide additional information to the HMD about yaw, theta, and roll information of the handheld device 862.

In some embodiments, at least one of the yaw, theta, and roll measurements may be collected and/or supplemented by the X-, Y-, and Z-positional information of a plurality of tracking objects. For example, FIG. 11 illustrates an embodiment of a handheld device 962 with a first tracking object 912-1 at a first location on the handheld device 962 and a second tracking object 912-2 at a second location displaced from the first tracking object 912-1. The first tracking object 912-1 may have a first reflectivity and the second tracking object 912-2 may have a second reflectivity, where the first reflectivity and the second reflectivity are different. The first reflectivity and the second reflectivity may allow differentiation of the first tracking object 912-1 and second tracking object 912-2.

The relative X-, Y-, and Z-positional information and/or movement of the first tracking object 912-1 and second tracking object 912-2 may allow the measurement of two of the yaw, theta, and roll information. For example, the location of the first tracking object 912-1 and the second tracking object 912-2 in FIG. 11, may allow the measurement of the theta and roll of the handheld device 962.

In some embodiments, a handheld device 962 with a first tracking object 912-1 and a second tracking object 912-2 may include a gyroscope 964 and/or an IMU 966 to measure the final direction of the yaw, theta, and roll not measured by the first tracking object 912-1 and second tracking object 912-2. In other embodiments, a handheld device 962 with a first tracking object 912-1 and a second tracking object 912-2 may include a gyroscope 964 and/or an IMU 966 as a redundancy. For example, one of the first tracking object 912-1 and second tracking object 912-2 may be occluded from the illuminator and/or camera, such as the second tracking object 912-2 being occluded by a user's hand. In such examples, the yaw, theta, and roll of the handheld device 962 may be measured by the gyroscope 964 and/or IMU 966.

FIG. 12 is a perspective view of another embodiment of a handheld device 1062 with a first tracking object 1012-1, a second tracking object 1012-2, and a third tracking object 1012-3. As described herein, tracking of the first tracking object 1012-1, second tracking object 1012-2, and third tracking object 1012-3 may allow the measurement of the location of each tracking object relative to the HMD. The first tracking object 1012-1 may have a first reflectivity, the second tracking object 1012-2 may have a second reflectivity, and the third tracking object 1012-3 may have a third reflectivity, where the first reflectivity, the second reflectivity, and the third reflectivity are different. The first reflectivity, the second reflectivity, and the third reflectivity may allow differentiation of the first tracking object 1012-1, second tracking object 1012-2, and third tracking object 1012-3.

Having three points allows the measurement of all six degrees of freedom, including X-, Y-, and Z-positional information and/or movement of the first tracking object 1012-1, second tracking object 1012-2, and third tracking object 1012-3 and the yaw, theta, and roll of the handheld device 1062. However, for redundancy against occlusion and for the confirmation of measurements, a handheld device 1062 may include a gyroscope 1064 and/or an IMU 1066 to measure yaw, theta, and roll in addition to the location information of the first tracking object 1012-1, second tracking object 1012-2, and third tracking object 1012-3. Additionally, even on a handheld device 1062 with a first tracking object 1012-1, second tracking object 1012-2, and third tracking object 1012-3, the handheld device 1062 may depart the FOI and/or FOV of the HMD. In such cases, a gyroscope 1064 and/or IMU 1066 may continue to provide information regarding the movement and/or orientation of the handheld device 1062 until the handheld device 1062 re-enters the FOI and FOV.

While potential benefits in tracking precision and/or degrees of freedom have been described herein, a plurality of tracking objects on the handheld device may provide additional benefits. For example, in an embodiment such as that described in relation to FIG. 12, the plurality of tracking objects 1012-1, 1012-2, 1012-3 may allow for greater precision and/or reliability. The plurality of tracking objects 1012-1, 1012-2, 1012-3 may be positioned about the handheld device 1062 to allow at least one tracking device of the plurality of tracking objects 1012-1, 1012-2, 1012-3 to be located toward the HMD. For example, depending on the orientation of the handheld device 1062, one or more of the tracking objects 1012-1, 1012-2, 1012-3 may be occluded or partially occluded from the FOV of the HMD. At least one of the tracking objects 1012-1, 1012-2, 1012-3 may remain in the FOV to allow continuous monitoring of the position of the handheld device 1062 during occlusion.

In at least one embodiment, a HMD and tracking object of the present disclosure may allow for precise depth measurements of the tracking object relative to the HMD without the need for a depth camera or other peripheral devices. In addition, one or more of a yaw, theta, and roll may be calculated without, or supplementary to, a gyroscope and/or IMU. A HMD and tracking object of the present disclosure may provide a low cost and high precision option for peripheral controller detection and monitoring for a HMD or other device.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. An object tracking system comprising:
an infrared illumination source mounted to a head mounted display;
an infrared sensitive camera mounted to the head mounted display; and
a handheld electronic device including a first tracking object with a first reflectivity in an infrared range.

2. The system of claim 1, the tracking object including a retroreflective surface.

3. The system of claim 1, the tracking object including a Lambertian surface.

4. The system of claim 1, the tracking object being at least partially spherical.

5. The system of claim 1, the head mounted display further comprising a processor configured to calculate X- and Y-position information of the first tracking object relative to a field of view of the head mounted display and calculate Z-position information of the first tracking object relative to the head mounted display based on a measured brightness of the first tracking object.

6. The system of claim 1, the handheld electronic device including at least one sensor to monitor at least one of yaw, pitch, and roll of the handheld electronic device.

7. The system of claim 1, further comprising a second tracking object having a second reflectivity in the infrared range, the second reflectivity being less than the first reflectivity.

8. A method of object tracking in a head-mounted display, the method comprising:
illuminating a field of view with an infrared illumination source;
capturing an infrared illuminated frame of the field of view with an infrared camera;
detecting a tracking object in the field of view;
calculating an x-position and a y-position of the tracking object in the field of view;
measuring a maximum brightness of the tracking object; and
calculating a position of the tracking object using the maximum brightness.

9. The method of claim 8, measuring the maximum brightness including measuring a centroid of the tracking object.

10. The method of claim 8, further comprising positioning the infrared illumination source and infrared camera equidistant from the tracking object.

11. The method of claim 8, further comprising capturing an ambient frame of the field of view and subtracting the ambient frame from the illuminated frame.

12. The method of claim 8, further comprising decreasing an illumination power of the infrared illumination source when the maximum brightness is greater than or equal to a saturation value.

13. The method of claim 8, further comprising increasing an illumination power of the infrared illumination source when the maximum brightness is less than or equal to a threshold value.

14. The method of claim 8, further comprising calculating rotation of the tracking object using one or more sensors connected to the tracking object.

15. The method of claim 8, further comprising calculating an area of the tracking object.

16. The method of claim 15, further comprising verifying a depth of the tracking object using the area of the tracking object.

17. A method of object tracking in a head-mounted display, the method comprising:
illuminating a field of view with an infrared illumination source mounted to the head-mounted display;
capturing an infrared illuminated frame of the field of view with an infrared camera mounted to the head-mounted display;
detecting a first tracking object on a handheld device in the field of view;
calculating a first x-position and a first y-position of the first tracking object in the field of view;
measuring a first maximum brightness of the first tracking object;
calculating a first depth of the first tracking object using the first maximum brightness;
detecting a second tracking object on the handheld device in the field of view;
calculating a second x-position and a second y-position of the second tracking object in the field of view;
measuring a second maximum brightness of the second tracking object; and
calculating a second depth of the second tracking object using the second maximum brightness.

18. The method of claim 17, further comprising calculating a pitch of the handheld device from the first tracking object and second tracking object.

19. The method of claim 17, further comprising:
detecting a third tracking object on the handheld device in the field of view;
calculating a third x-position and a third y-position of the third tracking object in the field of view;
measuring a third maximum brightness of the third tracking object; and
calculating a third depth of the third tracking object using the third maximum brightness.

20. The method of claim 19, further comprising calculating a yaw of the handheld device from the first tracking object, the second tracking object, and the third tracking object.
